(19) United States
(12) Patent Application Publication
(10) Pub. No.: US 2020/0396509 A1
(43) Pub. Date: Dec. 17, 2020

(54) METHODS AND APPARATUS FOR FACILITATING NETWORK CREDENTIAL UPDATES FOR MEDIA METERS

(71) Applicant: The Nielsen Company (US), LLC, New York, NY (US)

(72) Inventors: John T. Livoti, Clearwater, FL (US); Stanley Wellington Woodruff, Palm Harbor, FL (US); Rajakumar Madhanganesh, Tampa, FL (US); Arunkumar Pandey, Tampa, FL (US)

(21) Appl. No.: 16/442,448

(22) Filed: Jun. 14, 2019

(51) Int. Cl. H04N 21/475; H04N 21/442; H04L 12/707; H04N 21/24; H04N 21/647; H04N 21/658

(52) U.S. Cl. CPC H04N 21/4753; H04N 21/44222; H04N 21/6582; H04N 21/2407; H04N 21/64707; H04L 45/22

(57) ABSTRACT

Methods, apparatus, systems and articles of manufacture are disclosed for facilitating network credential updates for media meters. An example method disclosed herein includes accessing a monitoring record from a media monitor received over secondary communication network, determining, by executing an instruction with at least one processor, an Internet protocol (IP) address associated with a primary communication network based on a household associated with the monitoring record, transmitting a request to the IP address and in response to not receiving a response from the IP address, transmitting a notification to a mobile device associated with the household, the notification indicating that a network credential associated with the media monitor is to be updated.

### FIELD OF THE DISCLOSURE

This disclosure relates generally to media monitoring, and, more particularly, to methods and apparatus for facilitating network credential updates for media meters.

### BACKGROUND

Media providers and/or other entities such as advertising companies, broadcast networks, etc. are often interested in the viewing, listening, and/or media behavior of audience members and/or the public in general. The media usage and/or exposure habits of monitored audience members, as well as demographic data about the audience members, are collected and used to statistically determine the size and/or demographics of an audience of interest.

Traditionally, audience measurement entities determine audience engagement levels for media programming and/or advertisements based on registered panel members. That is, an audience measurement entity enrolls people who consent to be monitored into a panel. The audience measurement entity then monitors those panel members to collect media measurement data identifying media (e.g., television programs, radio programs, movies, DVDs, etc.) presented to those panel members. In this manner, the audience measurement entity can determine exposure measures for different media (e.g., content and/or advertisement) based on the collected media measurement data.

### BRIEF DESCRIPTION OF THE DRAWINGS

FIG. 1 illustrates an example environment of use including an example system for facilitating network credential updates for media meters.

FIG. 2 is a block diagram representing an example implementation of the example media meter of FIG. 1.

FIG. 3 is a block diagram representing an example implementation of the example audience measurement entity of FIG. 1.

FIG. 4 is a block diagram representing an example implementation of the example mobile device of FIG. 1.

FIG. 5 is a flowchart representative of machine readable instructions which may be executed to implement the media meter of FIGS. 1 and/or 2.

FIG. 6 is a flowchart representative of machine readable instructions which may be executed to implement the audience measurement entity of FIGS. 1 and/or 3.

FIG. 7 is a flowchart representative of machine readable instructions which may be executed to implement the mobile device of FIGS. 1 and/or 4.

FIG. 8 is a block diagram of an example processing platform structured to execute the instructions of FIG. 5 to implement the media meter of FIGS. 1 and/or 2.

FIG. 9 is a block diagram of an example processing platform structured to execute the instructions of FIG. 6 to implement the audience measurement entity of FIGS. 1 and/or 3.

FIG. 10 is a block diagram of an example processing platform structured to execute the instructions of FIG. 7 to implement the mobile device of FIGS. 1 and/or 5.

The figures are not to scale. In general, the same reference numbers will be used throughout the drawing(s) and accompanying written description to refer to the same or like parts. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Stating that any part is in “contact” with another part means that there is no intermediate part between the two parts. Although the figures show layers and regions with clean lines and boundaries, some or all of these lines and/or boundaries may be idealized. In reality, the boundaries and/or lines may be unobservable, blended, and/or irregular.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Media monitoring devices are installed by audience measurement entities (AMEs) into households including a user that has consented to having media monitoring performed. Some media meters communicate with a central facility of an AME over an internal network of the household (e.g., WiFi network, an Ethernet network, etc.). During installation of a media meter, a resident of the household provides a network credentials of the internal network (e.g., network name, a secure set identifier (SSID), network password, authentication type, etc.) to the media meter to enable the connection of the media meter to the internal network of the household. In some examples, the internal network interfaces with an external network (e.g., the Internet, etc.) via a gateway. In some examples, the connection to the internal network allows the media monitor to transmit monitoring records to the AME. In some examples, the provided password is not stored by the AME to ensure the privacy of the household but instead, remains stored locally to the media meter. As used herein, the terms “media monitor” and “media meter” are used interchangeably.

In some examples, if a media meter configured to transmit monitoring records via a household network is unable to transmit data via the household network, the media monitor can transmit the monitoring records over a secondary network connection (e.g., a cellular connection, a satellite connection, etc.). Transmitting monitoring records over the secondary network can incur unneeded costs to the AME because such secondary networks are often operated by third parties which charge the AME for use of the secondary network. In some examples, a media meter may be unable to connect to a primary network because of a service outage of the internal network of the household (e.g., a power outage at the household, a problem with the service provider, the residents of the household disabling their internal network, etc.). In other examples, a media meter may be unable to connect to a primary network as a result of the network credentials of the primary (e.g., internal) network changing. For example, a user might change the network credentials associated with the internal network without updating the network credentials used by the media monitor. In such examples, providing the updated network credentials to the media monitor will allow the media monitor to reconnect to the primary network and avoid the cost of transmitting monitoring records over the secondary network.

Methods, apparatus and systems disclosed herein enable a change in network credentials to be identified and new credentials provided. In such examples, a mobile device associated with a panelist of the household displays a prompt to request the panelist to provide the updated network credentials to the media monitor. In some examples disclosed herein, a mobile device application (sometimes referred to as an “app”) provides an interface to receive the updated network credentials and transmit the updated network credentials to the media monitor. In some examples disclosed herein, the mobile device deletes the network credentials (from a memory of the mobile device) after passing the network credentials to the media monitor. In some examples disclosed herein, when an AME receives a monitoring record via a secondary communication network, the AME can determine an address (e.g., an Internet Protocol address) of the household associated with the primary network. In some examples disclosed herein, the AME transmits a message to the determined address. In some examples, if no response is received from the determined address, the AME determines that a service outage (e.g., a connectivity outage, a power outage, etc.) has occurred at the household. In some examples disclosed herein, if a response is received from the determined IP address, the AME determines that the network credentials of primary connection have changed. In such an example, the AME transmits a notification to the mobile device app, causing the mobile device app to display a prompt and subsequently transmit the updated network credentials to the media meter.

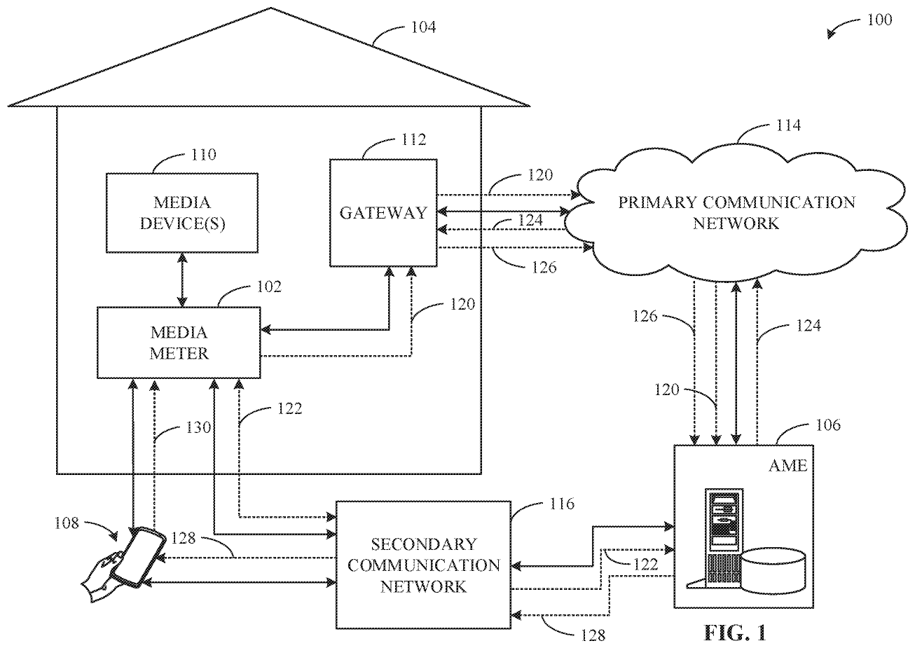

FIG. 1 illustrates an example environment of use 100 including an example media meter 102 The example environment of use 100 includes the example media meter 102 within an example household 104, an example AME 106, and an example mobile device 108. The example household 104 includes one or more example media device(s) 110 and an example gateway 112. The example gateway 112 allows devices in the household 104 (e.g., the media device(s) 110, the meter 102, the mobile device 108, etc.) to connect to an example primary communication network 114. The example media meter 102 can also communicate via an example secondary communication network 116.

The example media meter 102 of the illustrated example of FIG. 1 is a media monitoring device that is installed in the household 104 to monitor the media consumed on (e.g., presented by) the media device(s) 110. In the illustrated example of FIG. 1, the media meter 102 generates monitoring records of media consumed via the media device(s) 110. In some examples, the media meter 102 directly interfaces with the media device(s) 110 to monitor the media presented thereon. In some examples, the media meter 102 monitors traffic (e.g., network communications) transmitted over a network associated the household 104 (e.g., an internal network generated by the gateway 112, etc.) to identify media presented by the media device(s) 110. In some examples, the media meter 102 transmits the collected monitoring records to the AME 106 via the primary communication network 114 and/or a secondary communication network 116. For example, the media meter 102 may transmit the monitoring records to the AME 106 via the gateway 112 and primary communication network 114 or, alternatively, the media meter 102 may transmit the monitoring records to the AME 106 via the secondary communication network 116 (e.g., if the media meter 102 is unable to transmit such information via the primary communication network 114). In the illustrated example, the media meter 102 is an independent physical device (e.g., independent from the media device(s) 110, etc.). In other examples, some of or all of the media meter 102 is implemented software installed on an electronic device associate with the household 104. In some examples, the media meter 102 is incorporated in one or more of the media device(s) 110.

The example household 104 of the illustrated example of FIG. 1 is a residence of a media consumer. In other examples, the household 104 can be any area in which media is consumed (e.g., public transit, a business, etc.). In some examples, the household 104 is associated with a gateway 112 and has an address (e.g., an Internet protocol (IP) address) associated with the primary communication network 114. While example approaches disclosed herein are described in the context of an IP address being used, any other past, present, and/or future address and/or addressing scheme may additionally or alternatively be used to enable communications of the media meter 102 to be transmitted via the primary communication network 114.

The example AME 106 of the illustrated example of FIG. 1 is an entity that desires knowledge on how users interact with media devices such as smartphones, tablets, laptops, smart televisions, etc. In particular, the AME 106 seeks to monitor media presentations made at the media devices to, among other things, monitor exposure to advertisements, determine advertisement effectiveness, determine user behavior, identify purchasing behavior associated with various demographics, etc. In the illustrated example of FIG. 1, the example AME 106 receives monitoring records from the media meter 102 via the primary communication network 114 and/or the secondary communication network 116. In some examples, the AME 106 determines the IP address associated with the household 104 in response to a monitoring record (and/or any other message) received from the secondary communication network 116. In some examples, the AME transmits a message (e.g., an Internet Control Message Protocol (ICMP) message, commonly referred to as a “ping”) to the mobile device 108 and/or gateway 112. In some examples, the AME 106 determines if a service outage has occurred based on a lack of response to the message from the gateway 112. In some examples, the AME 106 determines if the media meter 102 is not connected to the gateway 112 based on a response from the gateway 112. In some examples, a service outage can be caused by a software and/or hardware problem associated with the household 104 and/or primary communication network 114, etc. In some examples, a service outage can be caused with the residents of the household 104 disable the media meter 102 (e.g., the residents leave for an extended period and power off the media meter 102 to lower energy costs, etc.).

The example mobile device 108 of the illustrated example of FIG. 1 is a mobile electronic device carried by a user (e.g., a panelist) associated with the household 104. In the illustrated example, the mobile device 108 is smart phone. In other examples, the mobile device 108 can be any other suitable electronic device (e.g., a tablet, a wearable, a laptop computer, etc.). In the illustrated example, the mobile device 108 includes a mobile device application that facilitates communicate between the mobile device 108 and the AME 106. In other examples, the AME 106 can communicate with the mobile device 108 via any other suitable means (e.g., text messages, voice mail, etc.). Accordingly, the AME 106 is able to present information to the user via the mobile device 108. For example, the AME 106, via the mobile device 108, transmits a request to the user to pass updated network credentials to the media meter 102. In the illustrated example, the mobile device 108 communicates directly with the media meter 102. In some examples, the mobile device 108 transmits updated network credentials to the media monitor via an intermediary (e.g., secondary communication network 116, etc.).

The example media device(s) 110 of the illustrated example of FIG. 1 are one or more devices that access media for presentation. In some examples, the media device(s) 110 are capable of directly presenting media (e.g., via a display). In other examples, the media device(s) 110 can present the media on separate media presentation equipment (e.g., speakers, a display, etc.). Thus, as used herein “media devices” may or may not be able to present media without assistance from a second device. Media devices are typically consumer electronics. For example, the media device(s) of the illustrated example are a smartphone and laptop computer, respectively, and thus, are capable of directly presenting media (e.g., via an integrated and/or connected display and speakers). Any other type(s) and/or number(s) of media device(s) can additionally or alternatively be used. For example, Internet-enabled mobile handsets (e.g., a smartphone, an iPod®, etc.), video game consoles (e.g., Xbox One®, PlayStation 4, etc.), tablet computers (e.g., an iPad®, a Motorola™ Xoom™, etc.), digital media players (e.g., a Roku® media player, a Slingbox®, a Tivo®, etc.), smart televisions, desktop computers, laptop computers, servers, etc. may additionally or alternatively be used.

The example gateway 112 of the illustrated example of FIG. 1 allows devices in the household 104 to communicate with external locations via the primary communication network 114. In some examples, the gateway 112 includes a wireless access point to support an internal network (e.g., WiFi, etc.) in the household 104. In some examples, the media meter 102 is directly coupled (e.g., via an ethernet cable, etc.) to the gateway 112. In other examples, the media monitor communicates with the gateway 112 over a wireless network generated by the gateway 112. In the illustrated example, to interface with the gateway 112, the media meter 102 communicates using network credentials. Such communications will not be successful if the proper network credentials are not used. That is, if the media meter 102 lacks proper network credentials (e.g., a username, a password, a network name, etc.), the media meter 102 will be unable to communicate via the gateway 112 and the primary communication network 114. In some examples, the gateway 112 is implemented as a hardware device. In other examples, the gateway 112 can be implemented via software. The example primary communication network 114 allows devices in the household 104 to communicate with external locations. In some examples, the primary communication network 114 is a network provided by an Internet Service Provider (e.g., a digital subscriber line (DSL), a fiber optic connection, cable-modem internet service, any other type of terrestrial internet connection, etc.) The primary communication network 114 enables the media meter 102 to communicate with the AME via the Internet.

The example secondary communication network 116 of the illustrated example of FIG. 1 is a network independent of the primary communication network 114. In the illustrated example, the media meter 102 is able to communicate with the AME 106 via the secondary communication network 116. In some examples, the secondary communication network 116 is a cellular network. In other examples, the secondary communication network 116 can be any other suitable network (e.g., a satellite network, a radio network, etc.).

The media meter 102 of the illustrated example of FIG. 1 gathers monitoring records by monitoring the media consumed via the media device(s) 110. In normal operation, the media meter 102 transmits such monitoring records via an example primary communication path 120. In the illustrated example, the primary communication path 120 allows the monitoring records to be transmitted to the AME 106 via the gateway 112 and the primary communication network 114. In some examples, if the primary communication path 120 is unavailable (e.g., the network credentials have changed, a service outage has occurred, etc.), the media meter 102 may transmit the monitoring records via the secondary communication path 122. In the illustrated example, an example secondary communication path 122 allows the monitoring records to be transmitted to the AME 106 via the secondary communication network 116.

In examples where primary communication path 120 is unavailable, the AME 106, in response to receiving monitoring records via the secondary communication path 122, determines the IP address associated with the gateway 112 and household 104. In such examples, the AME 106 transmits an example request 124 to the determined IP address. In some examples, if a service outage has occurred, the gateway 112 will not return a response to the AME 106. In such examples, the AME 106 determines a service outage has occurred at the household 104 based on the lack of response from the gateway 112. In some examples, if a service outage has not occurred, the gateway 112 will return an example response 126 to the AME 106. In such examples, the AME 106 determines that the media meter 102 is not able to communicate via the gateway 112 because of a lack of proper network credentials. In such examples, the AME 106 transmits an example notification 128 to the mobile device 108. In the illustrated example of FIG. 1, the notification 128 is transmitted via the secondary communication network 116. In other examples, the notification 128 can be transmitted via any other suitable communication network (e.g., the primary communication network 114, etc.). In the illustrated example, the mobile device 108, in response to receiving the notification, alerts a user of the mobile device 108 the network credentials must be updated. In some examples, after receiving the updated network credentials from the user, the mobile device 108 transmits a network credential message 130 to the media meter 102. In such examples, the media meter 102 uses the network credentials to reconnect to the gateway 112 and subsequently use the primary communication path 120 to transmit the monitoring records to the AME 106. In some examples, the mobile device 108 will delete the network credentials after the network credentials are set to the media meter 102.

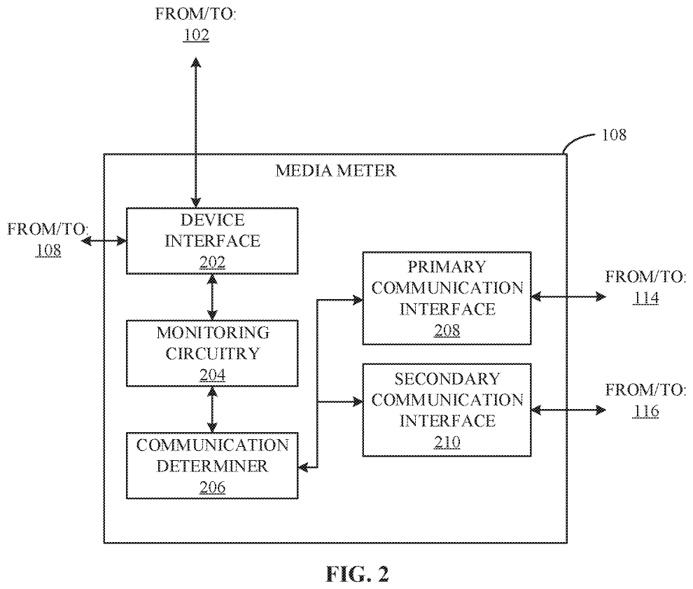

FIG. 2 is a block diagram detailing an example implementation of the example media meter 102 of FIG. 1. The example media meter 102 includes an example device interface 202, example monitoring circuitry 204, an example communication determiner 206, an example primary communication interface 208 and an example secondary communication interface 210.

The example device interface 202 of the illustrated example of FIG. 2 facilitates communication between the media meter 102 and the media device(s) 110. In some examples, the device interface 202 allows the media meter to monitor the media being presented via the media device(s) 110. For example, the device interface 202 receives the audio and/or video being presented via the media device(s) 110. In some examples, the device interface 202 facilitates communication between the media meter 102 and mobile device 108. In such examples, the device interface 202 receives information from the mobile device 108 (e.g., the network credentials messages 130, etc.). In some examples, the device interface 202 receives the audio and/or video being presented via the mobile device 108. In some examples, the device interface 202 uses the network credentials to snoop network traffic for online media consumptions. In some examples, the device interface 202 is implemented by a transceiver. In some examples, the device interface 202 is absent (e.g., if the media meter 102 is incorporated in the media device(s) 110, etc.).

The example monitoring circuitry 204 of the illustrated example of FIG. 2 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. The example monitoring circuitry 204 interprets the received audio and/or video to generate a monitoring record. For example, the monitoring circuitry 204 extracts embedded audio codes (e.g., watermarks, etc.) and/or generate signatures based on the monitored video and/or audio. In some examples, the monitoring circuitry 204 determines what residents of the household 104 when media was presented media device(s) 110. In such examples, the monitoring circuitry 204 can include any other suitable parameters in the monitoring record (e.g., a timestamp, tuning information, etc.).

The example communication determiner 206 of the illustrated example of FIG. 2 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. The example communication determiner 206 analyzes the received monitoring records to determine if the monitoring records are to be transmitted via the primary communication path 120 and/or the secondary communication path 122. For example, the communication determiner 206 determines if the media meter 102 is connected to a network associated with the gateway 112. In such examples, the communication determiner 206 causes the primary communication interface 208 to transmit the monitoring records via the primary communication path 120 if the media meter 102 is connected to a network associated with the gateway 112. In other examples, the communication determiner 206 causes the secondary communication interface 210 to transmit the monitoring records via the secondary communication path 122 if the media meter 102 is not connected to a network associated with the gateway 112.

The example primary communication interface 208 of the illustrated example of FIG. 2 allows the media meter 102 to connect to a network associated with the gateway 112. For example, the primary communication interface 208 can be implemented by WiFi hardware (e.g., a WiFi card, etc.). In some examples, the primary communication interface 208 is implemented via an ethernet connection between the media meter 102 and the gateway 112. In other examples, the primary communication interface 208 is implemented by any suitable combination of hardware and/or software. The example secondary communication interface 210 allows the media meter 102 to connect to the secondary communication network 116. For example, the secondary communication interface 210 can be implemented via a cellular modem. In other examples, the secondary communication interface 210 is implemented by any suitable combination of hardware and/or software.

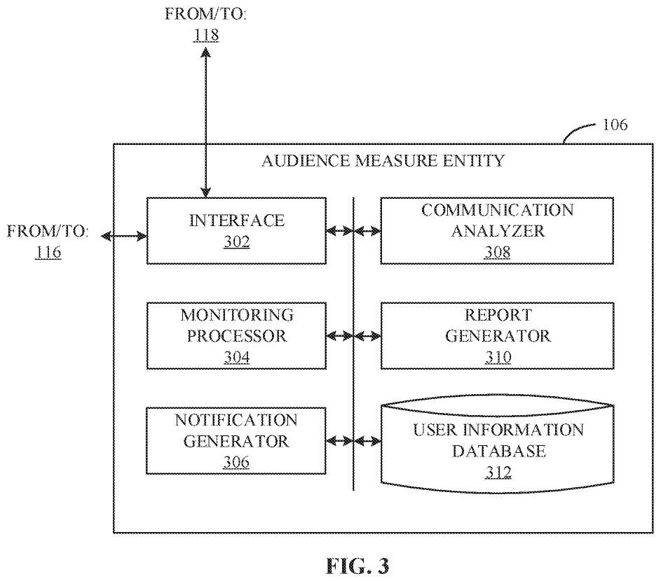

FIG. 3 is a block diagram detailing an example implementation of the example AME 106 of FIG. 1. The example AME 106 includes an example interface 302, an example monitoring processor 304, an example notification generator 306, an example communication analyzer 308, an example report generator 310 and an example user information database 312.

The example interface 302 of the illustrated example of FIG. 3 facilitates communication between the AME 106 and external locations and/or devices. For example, the interface 302 can be used to receive communications transmitted via the primary communication network 114 (e.g., the primary communication path 120, etc.) and/or the secondary communication network 116 (e.g., the secondary communication path 122, etc.). In some examples, the interface 302 is used to receive monitoring records from the media meter 102. In some examples, the interface 302 is used to transmit notifications to the mobile device 108 (e.g., the notification 128, etc.). In some examples, the interface 302 is implemented by any combination of suitable hardware and/or software.

The example communication analyzer 308 of the illustrated example of FIG. 3 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. The example communication analyzer 308 determines if the monitoring records were received via the primary communication network 114 or the secondary communication network 116. For example, the communication analyzer 308 communicates with the interface 302 to determine how the monitoring records were received. In other examples, the communication analyzer 308 can process the monitoring records to determine how the monitoring records were received.

The example monitoring processor 304 of the illustrated example of FIG. 3 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. The example monitoring processor 304 processes the monitoring records. For example, the monitoring processor 304 compares the captured audio codes and/or generated signatures to determine the identity of the media presented via the media device(s) 110. In some examples, the monitoring processor 304 correlates the determined media with the demographics associated with the residents of the household 104 (e.g., stored in the user information database 312, etc.).

The example notification generator 306 of the illustrated example of FIG. 3 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. The example notification generator 306 generates a notification to be sent to a user associate with a monitoring record. For example, in response to determining the monitor record was transmitted via the secondary communication network 116, the notification generator 306 queries the user information database 312 to determine the IP address associated with the primary communication network 114. The example user information database 312 contains user information. In some examples, the user information database 312 is used to determine an IP address associated with a monitoring record. In some examples, the notification generator 306 generates a notification for the user to update the network credentials. In such examples, the notification generator 306 causes the interface 302 to transmit the notification to the mobile device 108 (e.g., the notification 128 of FIG. 1).

The example report generator 310 of the illustrated example of FIG. 3 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. The example report generator 310 processes the monitoring record and/or the output of the monitoring processor 304 to generate an audience rating report. For example, the report generator 310 aggregates monitoring records to determine a quantity of viewers viewing a given media presentation. In some examples, the report generator 310 causes any suitable characteristics to be included in the audience rating report. In some examples, the report generator 310 causes the interface 302 to transmit the ratings report to an interested party.

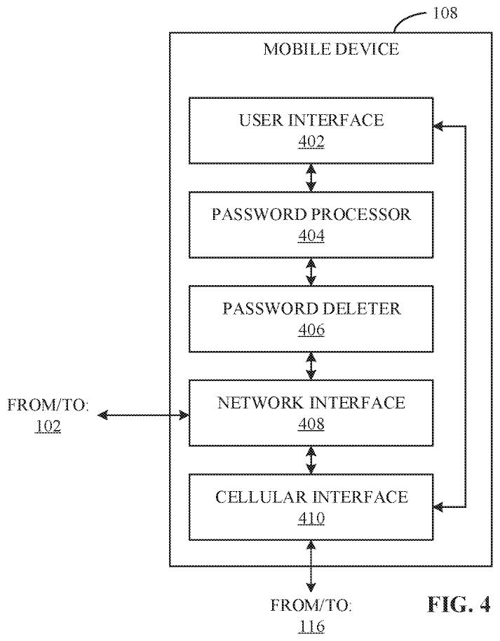

FIG. 4 is a block diagram detailing an example implementation the example mobile device 108 of FIG. 1. The example mobile device 108 includes an example user interface 402, an example password processor 404, an example password deleter 406, an example network interface 408, and an example cellular interface 410. In some examples disclosed herein, one or both of the example password processor 404 and the example password deleter 406 can be implemented via a mobile device application. In other examples, the password processor 404 and/or password deleter 406 be any suitable combination of hardware, software, etc.

The example user interface 402 of the illustrated example of FIG. 4 is an interface that allows a user of the mobile device 108 to input information into the mobile device 108. For example, the user interface 402 can be used to input text, images, audio, etc. In some examples, the user interface 402 is used to input network credentials. In some examples, the user interface 402 is implemented one or more by a display, camera, a touchscreen, a keyboard, etc.

The example password processor 404 of the illustrated example of FIG. 4 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. The example password processor 404 alerts a user of the mobile device 108 to update the user credentials of the media meter 102. For example, the password processor 404 can cause the user interface 402 of the mobile device 108 to present an alert via the user interface 402 in response to receiving the notification 128 from the AME 106. In some examples, the password processor 404 can cause one of or both of the network interface 408 and/or the cellular interface 410 to transmit the network credentials to the media meter 102.

The example password deleter 406 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. The example password deleter 406 deletes of the illustrated example of FIG. 4 the input password to prevent the password from being stored at the mobile device 108 (e.g., in a memory of the mobile device). In some examples, the password deleter 406 can also prevent the network credentials from being transmitted to the AME 106.

The example network interface 408 of the illustrated example of FIG. 4 allows the mobile device to connect to a network associated with the gateway 112. For example, the example network interface 408 can be implemented by WiFi hardware (e.g., a WiFi card, etc.).

The example cellular interface 410 allows the media meter to connect to the secondary communication network 116. For example, the cellular interface 410 can be implemented via a cellular modem.

While example manners of implementing the media meter 102, the AME 106 and the mobile device 108 of FIG. 1 are illustrated in FIGS. 2, 3, and/or 4, one or more of the elements, processes and/or devices illustrated in FIGS. 2, 3 and/or 4 may be combined, divided, re-arranged, omitted, eliminated and/or implemented in any other way. Further, the example device interface 202, the example monitoring circuitry 204, the example communication determiner 204, the example primary communication interface 208, the example secondary communication interface 210, and/or, more generally, the example media meter 102 of FIGS. 1 and/or 2; the example interface 302, the example communication analyzer 308, the example monitoring processor 304, the example report generator 310, the example notification generator 306, the example user information database 310, and/or, more generally, the example AME 106 of FIGS. 1 and/or 3; the example user interface 402, the example password processor 404, the example password deleter 406, the example network interface 408, the example cellular interface 410, and/or, more generally, the example mobile device 108 of FIGS. 1 and/or 4 may be implemented by hardware, software, firmware and/or any combination of hardware, software and/or firmware. Thus, for example, any of the example device interface 202, the example monitoring circuitry 204, the example communication determiner 204, the example primary communication interface 208, the example secondary communication interface 210, and/or, more generally, the example media meter 102 of FIGS. 1 and/or 2; the example interface 302, the example communication analyzer 308, the example monitoring processor 304, the example report generator 310, the example notification generator 306, the example user information database 310, and/or, more generally, the example AME 106 of FIGS. 1 and/or 3; the example user interface 402, the example password processor 404, the example password deleter 406, the example network interface 408, the example cellular interface 410, and/or, more generally, the example mobile device 108 of FIGS. 1 and/or 4 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, device interface 202, the example monitoring circuitry 204, the example communication determiner 204, the example primary communication interface 208, the example secondary communication interface 210, and/or, more generally, the example media meter 102 of FIGS. 1 and/or 2; the example interface 302, the example communication analyzer 308, the example monitoring processor 304, the example report generator 310, the example notification generator 306, the example user information database 310, and/or, more generally, the example AME 106 of FIGS. 1 and/or 3; the example user interface 402, the example password processor 404, the example password deleter 406, the example network interface 408, the example cellular interface 410, and/or, more generally, the example mobile device 108 of FIGS. 1 and/or 4 is/are hereby expressly defined to include a non-transitory computer readable storage device or storage disk such as a memory, a digital versatile disk (DVD), a compact disk (CD), a Blu-ray disk, etc. including the software and/or firmware. Further still, the example the example media meter 102 of FIGS. 1 and/or 2, the example AME 106 of FIGS. 1 and/or 3, and/or the example mobile device 108 of FIGS. 1 and/or 4 may include one or more elements, processes and/or devices in addition to, or instead of, those illustrated in FIGS. 1, 2, 3, and/or 4, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

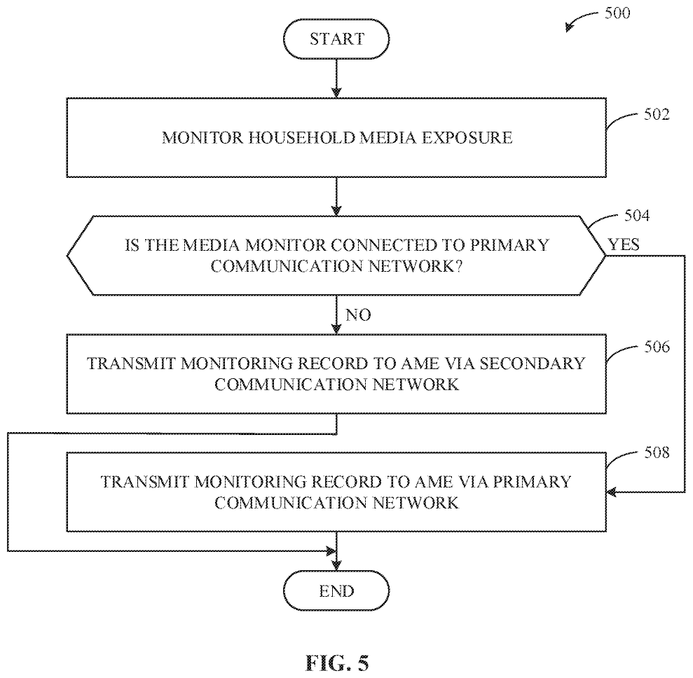

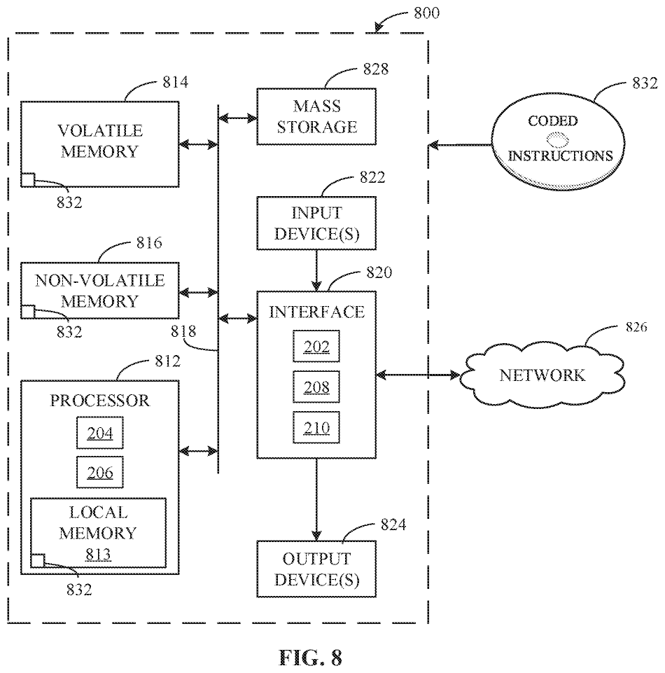

A flowchart representative of example hardware logic, machine readable instructions, hardware implemented state machines, and/or any combination thereof for implementing the media meter 102 of FIGS. 1 and/or 2 is shown in FIG. 5. The machine readable instructions may be one or more executable programs or portion(s) of an executable program for execution by a computer processor such as the processor 812 shown in the example processor platform 800 discussed below in connection with FIG. 8. The program may be embodied in software stored on a non-transitory computer readable storage medium such as a CD-ROM, a floppy disk, a hard drive, a DVD, a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowchart illustrated in FIG. 5, many other methods of implementing the example media meter 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

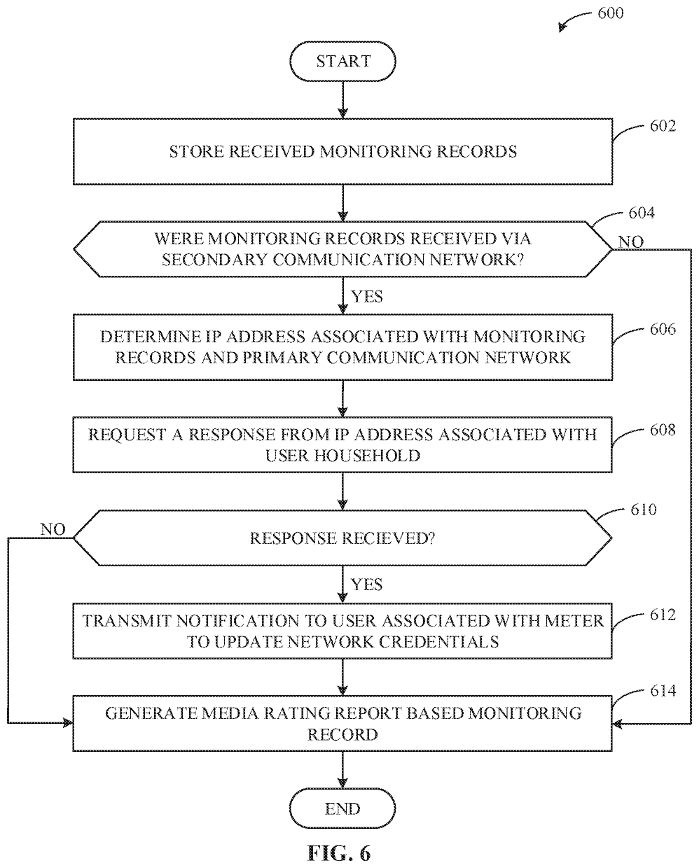

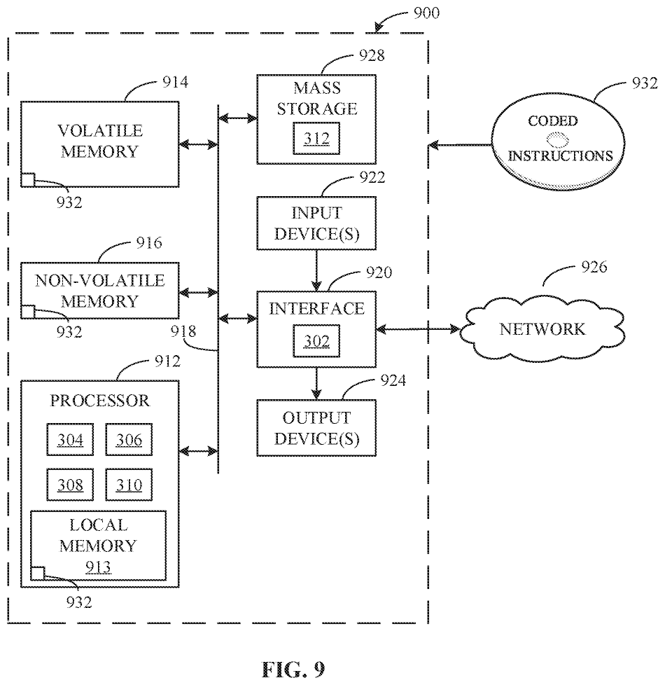

A flowchart representative of example hardware logic, machine readable instructions, hardware implemented state machines, and/or any combination thereof for implementing the AME 106 of FIGS. 1 and/or 3 is shown in FIG. 6 The machine readable instructions may be one or more executable programs or portion(s) of an executable program for execution by a computer processor such as the processor 912 shown in the example processor platform 900 discussed below in connection with FIG. 9. The program may be embodied in software stored on a non-transitory computer readable storage medium such as a CD-ROM, a floppy disk, a hard drive, a DVD, a Blu-ray disk, or a memory associated with the processor 912, but the entire program and/or parts thereof could alternatively be executed by a device other than the processor 912 and/or embodied in firmware or dedicated hardware. Further, although the example program is described with reference to the flowchart illustrated in FIG. 6, many other methods of implementing the example AME 106 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

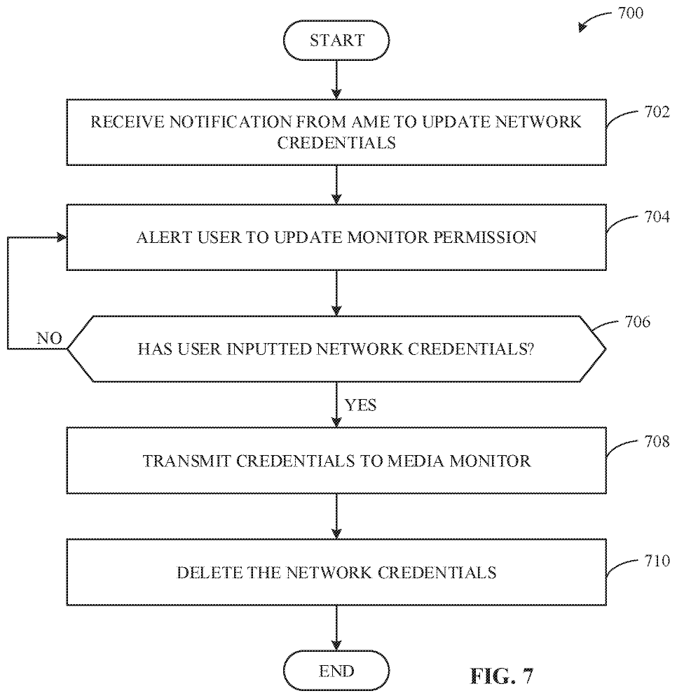

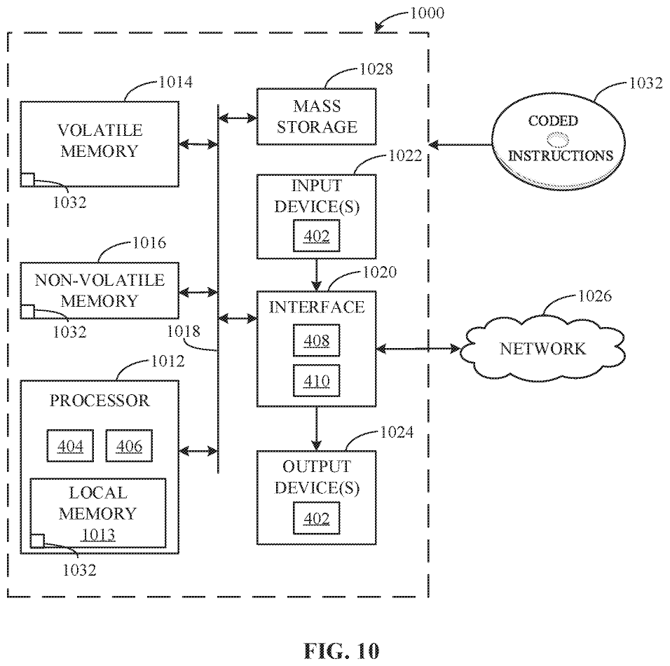

A flowchart representative of example hardware logic, machine readable instructions, hardware implemented state machines, and/or any combination thereof for implementing the mobile device 108 of FIGS. 1 and/or 4 is shown in FIG. 7. The machine readable instructions may be one or more executable programs or portion(s) of an executable program for execution by a computer processor such as the processor 1012 shown in the example processor platform 1000 discussed below in connection with FIG. 10. The program may be embodied in software stored on a non-transitory computer readable storage medium such as a CD-ROM, a floppy disk, a hard drive, a DVD, a Blu-ray disk, or a memory associated with the processor 1012, but the entire program and/or parts thereof could alternatively be executed by a device other than the processor 1012 and/or embodied in firmware or dedicated hardware. Further, although the example program is described with reference to the flowchart illustrated in FIG. 4, many other methods of implementing the example mobile device 108 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 5, 6, and/or 7 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

The example process 500 of FIG. 5 begins at block 502, where the monitoring circuitry 204 monitors the household media exposure. (Block 502). For example, the monitoring circuitry 204 processes the audio and/or video presented on the media device(s) 110 and received via the device interface 202. In some examples, the monitoring circuitry detects codes embedded in the media presented via the media device(s) 110. In some examples, the monitoring circuitry 204 generates signatures based on the media. In some examples, the monitoring circuitry 204 generates a monitoring record based of the monitored media.

The communication determiner 206 determines if the media meter 102 is connected to the primary communication network 114. (Block 504). That is, the communication determiner 206 determines if the media monitor is able to connect to the primary communication network 114 via the primary communication interface 208. In some such examples, the communication determiner 206 may determine that media meter 102 does not have the proper network credentials to connect to the primary communication network 114, may determine that the media meter 102 is not able to communicate with the gateway 112, etc.

If the communication determiner 206 determines the media meter 102 is not connected to the primary communication network 114 (e.g., block 504 returns a result of NO), the secondary communication interface 210 transmits a monitoring record to the AME 106 via the secondary communication network 116. (Block 506).

If the communication determiner 206 determines the media meter 102 is connected to the primary communication network 114 (e.g., block 504 returns a result of YES), the primary communication interface 208 transmits a monitoring record to the AME via the primary communication network 114. (Block 508). The process 500 of FIG. 5 then terminates but may be repeated upon, for example, a subsequent identification of media, a determination that a threshold amount of monitoring records has been collected, a determination that a threshold amount of time has elapsed since a prior transmission of a monitoring record, etc.

The example process 600 of FIG. 6 begins at block 602, where the interface 302 accesses monitoring records received from the media meter 102 (e.g., via the primary communication network 114, via the secondary communication network 116) The communication analyzer 308 determines if the monitoring records were received via the secondary communication network 116. (Block 604). For example, the communication analyzer 308 analyzes the received monitoring records to determine if the monitoring records were received via the primary communication network 114 and/or the secondary communication network 116. In some examples, the communication analyzer 308 communicates with the interface 302 to determine if the monitoring records were received via the primary communication network 114 and/or the secondary communication network 116. In other examples, the communication analyzer 308 can determine if the monitoring records were received from the secondary communication network 116 by any other suitable means.

If the communication analyzer 308 determines that the monitoring record(s) were received via the secondary communication network 116 (e.g., block 604 returns a result of YES), the monitoring processor 304 determines an address (e.g., an IP address) associated with the media meter when communicating via the primary communication network 114. (Block 606). For example, the monitoring processor 304 queries a user information database 312 to determine the IP address associated with the media meter 102 (and/or, more generally, the household 104) from which the monitoring record was received. In other examples, the monitoring processor 304 determines the IP address associated with the monitoring records and the primary communication network 114 by any other suitable means.

The notification generator 306 transmits a message to the identified address. (Block 608). In examples disclosed herein, the message requests a response from the gateway 112 of the household 104. In examples disclosed herein, the message is implemented using an Internet Control Message Protocol (ICMP) message (commonly referred to as a “ping”). However, any other type of message may additionally or alternatively be used to determine whether there is a service outage at the household 104. In such examples, the notification generator 306 attempts to communicate with the gateway 112 over the primary communication network 114. In some examples, if the request generated by notification generator 306 is able to reach the gateway 112, the gateway 112 will transmit a response to the AME 106. In other examples, if the request generated by the notification generator 306 is unable to reach the gateway 112, no response will be sent in return.

The communication analyzer 308 determines if a response was received from the IP address. (Block 610). For example, the communication analyzer 308 queries the interface 302 to determine whether a response was received. In some examples, a response may be considered to be received when it is received within a threshold amount of time from transmission of the initial request message (e.g., one second, ten seconds, one minute, etc.) If the communication analyzer 308 determines that a response was received (e.g., block 610 returns a result of YES), the example interface 302 transmits a notification to a user associated with a media meter 102 to request an update of the network credentials. (Block 612). For example, the notification generator 306 may use the interface 302 to transmit a notification (e.g., the notification message 128, etc.) to a user associated with the media meter 102. For example, the interface 302 transmits a notification to the mobile device 108 associated with the household 104. In some examples, the notification is presented via a user interface of the mobile device 108 to update the network credentials associated with the household 104. An example process of displaying a prompt for updated credentials and updating those credentials at the media monitor 102 is described in further detail below in connection with FIG. 7.

Upon the example communication analyzer 308 determining the monitoring records were not received via the secondary communication network 116 (e.g., block 604 returns a result of NO), the example communication analyzer 308 determining a response was received from the IP address (e.g., block 610 returns a result of NO), and/or the example interface 302 transmits a notification to a user associated with a media meter 102 to request an update of the network credentials , the report generator 310 generates a report based on the stored monitoring records. (Block 616). For example, the report generator 310 aggregates monitoring records to estimate the number of people viewing a particular media presentation. In other examples, the report generator 310 generates a media rating report based on the media monitoring record by any other suitable means. The process 600 of FIG. 6 then terminates, but may be performed upon, for example, additional records are received over the secondary monitoring networks, a threshold period of time is exceeded, etc.

The process 700 of FIG. 7 begins at block 702, where the cellular interface 410 and/or the network interface 408 receives a notification from AME 106 to update network credentials. (Block 702). For example, the cellular interface 410 and/or the network interface 408 receives a notification transmitted in response to the AME 106 determining that the media meter 102 is not connected to the gateway 112. In some examples, the notification is a push notification. The user interface 402 prompts a user to update network credentials of the media monitor. (Block 704). For example, the user interface 402 may present a visual notification to the user to update the network credentials. In some examples, the user interface 402 presents an audible notification to request the user to update the network credentials. Additionally or alternatively, the user interface 402 may alert the user of the mobile device 108 by any other suitable means (e.g., vibrating the mobile device 108, etc.). In some examples, the user interface 402 presents present a user interface (e.g., a graphical user interface (GUI)) to input the updated network credentials.

The password processor 404 determines if the user has input the network credentials. (Block 706). For example, the password processor 404 determined if the user of the mobile device 108 has input the updated network credentials via the user interface 402. If no network credentials have been entered (e.g., block 706 returns a result of NO), control returns to block 704. If the password processor 404 detects the user has input the updated the network credentials (e.g., block 706 returns a result of YES), the network interface 408 and/or the cellular interface 410 transmits the updated network credentials to the media meter 102. (Block 708). For example, the example network interface 408 and/or the cellular interface 410 transmits the updated network credentials to the media meter 102 via Bluetooth. In other examples, the mobile device 108 transmits the updated network credentials by any other means (e.g., the example secondary communication network 116, a physical connection, etc.). Upon transmission of the credentials to the media meter 102 the password deleter 406 deletes the network credentials. (Block 710). For example, the password deleter 406 removes the network credentials from a memory of the mobile device 108. In some examples, the password deleter 406 also prevents the network credentials from being transported to the AME 106. The process 700 of FIG. 7 then terminates, but may be repeated upon, for example an additional notification is received from the AME 106, a threshold time has been exceeded and updated network credentials have not been provided to the media meter 102, etc.

FIG. 8 is a block diagram of an example processor platform 800 structured to execute the instructions of FIGS. 5 to implement the media meter 102 of FIGS. 1 and/or 2. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 800 of the illustrated example includes a processor 812. The processor 812 of the illustrated example is hardware. For example, the processor 812 can be implemented by one or more integrated circuits, logic circuits, microprocessors,

GPUs, DSPs, or controllers from any desired family or manufacturer. The hardware processor may be a semiconductor based (e.g., silicon based) device. In this example, the processor implements the example device interface 202 and the communication determiner 206.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), a Bluetooth® interface, a near field communication (NFC) interface, and/or a PCI express interface. In this example, the interface circuit 820 implements the example device interface 202, the example primary communication interface 208 and the example secondary communication interface 210.

In the illustrated example, one or more input devices 822 are connected to the interface circuit 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 820 of the illustrated example, thus, typically includes a graphics driver card, a graphics driver chip and/or a graphics driver processor.

The interface circuit 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives.

The machine executable instructions 832 of FIG. 5 may be stored in the mass storage device 828, in the volatile memory 814, in the non-volatile memory 816, and/or on a removable non-transitory computer readable storage medium such as a CD or DVD.

FIG. 9 is a block diagram of an example processor platform 900 structured to execute the instructions of FIG. 6 to implement the AME 106 of FIGS. 1 and/or 3. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 900 of the illustrated example includes a processor 912. The processor 912 of the illustrated example is hardware. For example, the processor 912 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example communication analyzer 308, the example monitoring processor 304, the example report generator 310 and the example notification generator 306.

The processor 912 of the illustrated example includes a local memory 913 (e.g., a cache). The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), a Bluetooth® interface, a near field communication (NFC) interface, and/or a PCI express interface. In this example, the interface circuit implements the example interface 320.

In the illustrated example, one or more input devices 922 are connected to the interface circuit 920. The input device(s) 922 permit(s) a user to enter data and/or commands into the processor 912. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 920 of the illustrated example, thus, typically includes a graphics driver card, a graphics driver chip and/or a graphics driver processor.

The interface circuit 920 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 926. The communication can be via, for example, an Ethernet connection, a digital subscriber line (DSL) connection, a telephone line connection, a coaxial cable system, a satellite system, a line-of-site wireless system, a cellular telephone system, etc.

The processor platform 900 of the illustrated example also includes one or more mass storage devices 928 for storing software and/or data. Examples of such mass storage devices 928 include floppy disk drives, hard drive disks, compact disk drives, Blu-ray disk drives, redundant array of independent disks (RAID) systems, and digital versatile disk (DVD) drives. In this example, the mass storage device(s) implement the example user information database 312. In other examples, the user information database 312 can be implemented in any other suitable manner (e.g., by the non-volatile memory 316, by the volatile memory 914, by the local memory 913, by a removable non-transitory computer readable storage medium, etc.).

The machine executable instructions 932 of FIG. 6 may be stored in the mass storage device 928, in the volatile memory 914, in the non-volatile memory 916, and/or on a removable non-transitory computer readable storage medium such as a CD or DVD.

FIG. 10 is a block diagram of an example processor platform 1000 structured to execute the instructions of FIG. 7 to implement the mobile device 108 of FIGS. 1 and/or 4. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1000 of the illustrated example includes a processor 1012. The processor 1012 of the illustrated example is hardware. For example, the processor 1012 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example password processor 404 and the example password deleter 406.

The processor 1012 of the illustrated example includes a local memory 1013 (e.g., a cache). The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1016 may be implemented by flash memory and/or any other desired type of memory device. Access to the main memory 1014, 1016 is controlled by a memory controller.

The processor platform 1000 of the illustrated example also includes an interface circuit 1020. The interface circuit 1020 may be implemented by any type of interface standard, such as an Ethernet interface, a universal serial bus (USB), a Bluetooth® interface, a near field communication (NFC) interface, and/or a PCI express interface. In this example, the interface circuit 1020 implements the example network interface 408 and the example cellular interface 410.

In the illustrated example, one or more input devices 1022 are connected to the interface circuit 1020. The input device(s) 1022 permit(s) a user to enter data and/or commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1024 are also connected to the interface circuit 1020 of the illustrated example. The output devices 1024 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1020 of the illustrated example, thus, typically includes a graphics driver card, a graphics driver chip and/or a graphics driver processor. In this example, the output device(s) 1024 and/or the input device(s) 1022 implement the example user interface 402.

The interface circuit 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1026. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1000 of the illustrated example also includes one or more mass storage devices 1028 for storing software and/or data. Examples of such mass storage devices 1028 include floppy disk drives, hard drive disks, compact disk drives, Blu-ray disk drives, redundant array of independent disks (RAID) systems, and digital versatile disk (DVD) drives.

The machine executable instructions 1032 of FIG. 7 may be stored in the mass storage device 1028, in the volatile memory 1014, in the non-volatile memory 1016, and/or on a removable non-transitory computer readable storage medium such as a CD or DVD.

From the foregoing, it will be appreciated that example methods, apparatus and articles of manufacture have been disclosed that facilitate the network credential updates for media monitors. The disclosed methods, apparatus and articles of manufacture improve the efficiency of using a computing device by the ensuring media monitors are using the most cost efficient communication network and are able to re-establish a communication path via a primary communication network. The disclosed methods, apparatus and articles of manufacture are accordingly directed to one or more improvement(s) in the functioning of a computer.

Example 1 includes an apparatus comprising an interface to access a monitoring record from a media monitor received over a secondary communication network, a communication analyzer to determine an IP address associated with a primary communication network based on a household associated with the monitoring record, and a notification generator to transmit a request to the IP address, and in response to not receiving a response from the IP address, transmit a notification to a mobile device associated with the household, the notification indicating that a network credential associated with the media monitor is to be updated.

Example 2 includes the apparatus of example 1, wherein the communication analyzer is further to, in response to receiving the response from the IP address, determine that a service outage has occurred at the household, the service outage preventing the media monitor from transmitting the monitoring record over the primary communication network.

Example 3 includes the apparatus of example 1, further including a report generator to generate a media rating report based on the monitoring record.

Example 4 includes the apparatus of example 1, wherein the network credential is used by the media monitor to connect to a local area network associated with the household.

Example 5 includes the apparatus of example 1, wherein the secondary communication network is a cellular network.

Example 6 includes a non-transitory computer readable medium including instructions, which when executed, cause a processor to store a monitoring record from a media monitor received over a secondary communication network, determine an IP address associated with a primary communication network based on a household associated with the monitoring record, transmit a request to the IP address, and in response to not receiving a response from the IP address, transmit a notification to a mobile device associated with the household, the notification indicating that a network credential associated with the media monitor is to be updated.

Example 7 includes the non-transitory computer readable medium of example 6, wherein the instructions further cause the processor to, in response to receiving the response from the IP address, determine that a service outage has occurred at the household, the service outage preventing the media monitor from transmitting the monitoring record over the primary communication network.

Example 8 includes the non-transitory computer readable medium of example 6, wherein the instructions further cause the processor to generate a media rating report based on the monitoring record.

Example 9 includes the non-transitory computer readable medium of example 6, wherein the network credential is used by the media monitor to connect to a local area network associated with the household.

Example 10 includes the non-transitory computer readable medium of example 6, wherein the secondary communication network is a cellular network.

Example 11 includes a method comprising accessing a monitoring record from a media monitor received over a secondary communication network, determining, by executing an instruction with at least one processor, an Internet protocol (IP) address associated with a primary communication network based on a household associated with the monitoring record, transmitting a request to the IP address, and in response to not receiving a response from the IP address, transmitting a notification to a mobile device associated with the household, the notification indicating that a network credential associated with the media monitor is to be updated.

Example 12 includes the method of example 11, further including in response to receiving the response from the IP address, determining that a service outage has occurred at the household, the service outage preventing the media monitor from transmitting the monitoring record over the primary communication network.

Example 13 includes the method of example 11, further including generating a media rating report based on the monitoring record.

Example 14 includes the method of example 11, wherein the network credential is used by the media monitor to connect to a local area network associated with the household.

Example 15 includes the method of example 11, wherein the secondary communication network is a cellular network.

Example 16 includes an apparatus comprising means for accessing a monitoring record from a media monitor received over a secondary communication network, means for determining an IP address associated with a primary communication network based on a household associated with the monitoring record, and means for generating to transmit a request to the IP address, and in response to not receiving a response from the IP address, transmit a notification to a mobile device associated with the household, the notification indicating that a network credential associated with the media monitor is to be updated. The example means for accessing may be implemented by the example interface 302 of FIG. 3. The example means for determining may be implemented by the example communications analyzer 308 of FIG. 3. The example means for generating may be implemented by the example notification generator 306 of FIG. 3.

Example 17 includes the apparatus of example 16, wherein the means for determining is further to, in response to receiving the response from the IP address, determine that a service outage has occurred at the household, the service outage preventing the media monitor from transmitting the monitoring record over the primary communication network.

Example 18 includes the apparatus of example 16, further including means for creating a media rating report based on the monitoring record. The example means for creating may be implemented by the example report generator 310 of FIG. 3.

Example 19 includes the apparatus of example 16, wherein the network credential is used by the media monitor to connect to a local area network associated with the household.

Example 20 includes the apparatus of example 16, wherein the secondary communication network is a cellular network.

Example 21 includes a method comprising accessing a notification from an audience measurement entity at a processor of a mobile device, the notification indicating that a network credential associated with a media monitor is to be updated, the notification sent in response to a monitoring record being received at the audience measurement entity from the media monitor via a secondary communication network, presenting an alert requesting that a user update the network credential, and in response to receiving the updated network credential, transmitting the updated network credential to the media monitor.

Example 22 includes the method of example 21, further including deleting the network credential.

Example 23 includes the method of example 21, wherein the secondary communication network is a cellular network.

Example 24 includes the method of example 21, wherein the network credential is used by the media monitor to connect to a local network associated with a household associated with the media monitor.

Example 25 includes the method of example 21, wherein the network credential allows the media monitor to transmit the monitoring record over a primary communication network.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. An apparatus comprising:
an interface to access a monitoring record from a media monitor received over a secondary communication network;
a communication analyzer to determine an IP address associated with a primary communication network based on a household associated with the monitoring record; and
a notification generator to:
transmit a request to the IP address; and
in response to not receiving a response from the IP address, transmit a notification to a mobile device associated with the household, the notification indicating that a network credential associated with the media monitor is to be updated.

2. The apparatus of claim 1, wherein the communication analyzer is further to, in response to receiving the response from the IP address, determine that a service outage has occurred at the household, the service outage preventing the media monitor from transmitting the monitoring record over the primary communication network.

3. The apparatus of claim 1, further including a report generator to generate a media rating report based on the monitoring record.

4. The apparatus of claim 1, wherein the network credential is used by the media monitor to connect to a local area network associated with the household.

5. The apparatus of claim 1, wherein the secondary communication network is a cellular network.

6. A non-transitory computer readable medium including instructions, which when executed, cause a processor to:
store a monitoring record from a media monitor received over a secondary communication network;
determine an IP address associated with a primary communication network based on a household associated with the monitoring record;
transmit a request to the IP address; and
in response to not receiving a response from the IP address, transmit a notification to a mobile device associated with the household, the notification indicating that a network credential associated with the media monitor is to be updated.

7. The non-transitory computer readable medium of claim 6, wherein the instructions further cause the processor to, in response to receiving the response from the IP address, determine that a service outage has occurred at the household, the service outage preventing the media monitor from transmitting the monitoring record over the primary communication network.

8. The non-transitory computer readable medium of claim 6, wherein the instructions further cause the processor to generate a media rating report based on the monitoring record.

9. The non-transitory computer readable medium of claim 6, wherein the network credential is used by the media monitor to connect to a local area network associated with the household.

10. The non-transitory computer readable medium of claim 6, wherein the secondary communication network is a cellular network.

11. A method comprising:
accessing a monitoring record from a media monitor received over a secondary communication network;
determining, by executing an instruction with at least one processor, an Internet protocol (IP) address associated with a primary communication network based on a household associated with the monitoring record;
transmitting a request to the IP address; and
in response to not receiving a response from the IP address, transmitting a notification to a mobile device associated with the household, the notification indicating that a network credential associated with the media monitor is to be updated.

12. The method of claim 11, further including in response to receiving the response from the IP address, determining that a service outage has occurred at the household, the service outage preventing the media monitor from transmitting the monitoring record over the primary communication network.

13. The method of claim 11, further including generating a media rating report based on the monitoring record.

14. The method of claim 11, wherein the network credential is used by the media monitor to connect to a local area network associated with the household.

15. The method of claim 11, wherein the secondary communication network is a cellular network.

16-25. (canceled)
